(19) United States
(12) Patent Application Publication
(10) Pub. No.: US 2023/0195536 A1
(43) Pub. Date: Jun. 22, 2023

(54) DATA OFFLOADING PROCESSES AND SYSTEMS

(71) Applicant: Intel Corporation, Santa Clara, CA (US)

(72) Inventors: Marcin SPOCZYNSKI, Leixlip (IE); Nageen HIMAYAT, Fremont, CA (US); Srikathyayani SRIKANTESWARA, Portland, OR (US); Hao FENG, Hillsboro, OR (US); Yi ZHANG, San Jose, CA (US); S M Iftekharul ALAM, Hillsboro, OR (US); Rath VANNITHAMBY, Portland, OR (US)

(21) Appl. No.: 17/557,063

(22) Filed: Dec. 21, 2021

(51) Int. Cl. G06F 9/50

(52) U.S. Cl. CPC G06F 9/5083; G06F 9/505; G06F 9/5016; G06F 9/5044; G06F 2209/508; G06F 2209/5022

(57) ABSTRACT

A device may include a processor. The processor may sample a portion of a workload to offload to compute resources and a portion of a current workload of the compute resources. The processor may simulate offloading of the workload to the compute resources using the sampled portion of the workload, the sampled portion of the current workload, and telemetry data corresponding to the compute resources. The compute resources may be configured to perform the workload according to a plurality of offloading configurations. The processor may determine a rank score for each offloading configuration of the plurality of offloading configurations based on the simulations. Responsive to a rank score corresponding to an offloading configuration of the plurality of offloading configurations exceeding a threshold value, the processor may offload the workload to the compute resource corresponding to the offloading configuration that corresponds to the rank score that exceeds the threshold value.

### FIELD

The embodiments discussed in the present disclosure are related to data offloading processes and systems.

### BACKGROUND

Unless otherwise indicated in the present disclosure, the materials described in the present disclosure are not prior art to the claims in the present application and are not admitted to be prior art by inclusion in this section.

Wireless communication systems may include an edge device. The edge device may be configured to offload a workload (e.g., communication protocols, network stacks, etc.) to a compute resource within a remote device configured as a network device (e.g., a cloud device).

The subject matter claimed in the present disclosure is not limited to aspects that solve any disadvantages or that operate only in environments such as those described above. Rather, this background is only provided to illustrate one example technology area where some aspects described in the present disclosure may be practiced.

### BRIEF DESCRIPTION OF THE DRAWINGS

Example aspects will be described and explained with additional specificity and detail through the use of the accompanying drawings in which:

FIG. 1 illustrates a block diagram of an exemplary operational environment to offload a workload to a compute resource;

FIG. 2 illustrates a block diagram of an exemplary compute resource;

FIG. 3 illustrates a flowchart of an exemplary method to offload a workload to a compute resource; and

FIG. 4 illustrates a flowchart of an exemplary method to offload a workload to a compute resource,

all according to at least one embodiment described in the present disclosure.

### DETAILED DESCRIPTION

Wireless communication systems may include a device (e.g., an edge device) configured to offload a workload (e.g., communication protocols, network stacks, etc.) to a remote device configured as a network device (e.g., a cloud device). The workload may be offloaded from a compute resource within the device to a remote compute resource within the remote device. The remote compute resource and the compute resource may each include a cross-architecture processing unit (xPU), a field programmable gate array (FPGA), an application-specific integrated circuit (ASIC), a general processing unit (GPU), a central processing unit (CPU), a network interface card (NIC), or some combination thereof. The remote compute resource and the compute resource may be configured to be deployed within a fifth generation (5G) network, a wireless fidelity (Wi-Fi) network, an ethernet network, or any other appropriate network. The remote compute resource and the compute resource may include corresponding capacity settings which may be limited by memory, memory utilization, input output (IO) bandwidth, or some combination thereof.

The device may offload the workload based on settings within the device and capabilities of the compute resource, the remote compute resource, or some combination thereof. For example, the device may offload the workload based on a power consumption setting, a computing power setting, a throughput setting, an IO bandwidth setting, a memory setting, or some combination thereof.

The device may offload the workload based on an offloading configuration. The device may store multiple offloading configurations in a memory. An offloading configuration that is operational but not implemented by the device may be stored in the memory to. Storing the non-implemented offloading configuration in the memory may permit the device to implement another offloading configuration that would not have previous been operational due to limitations of the device. The remote compute resource may process the workload using one or more unused cycles, which may permit the workload to be divided between the compute resource and the remote compute resource.

Some offloading technologies may use large amounts of information about the workload to offload the workload. In these and other offloading technologies, the offloading configurations may be pre-installed on the device or statically loaded.

One or more aspect described in the present disclosure may dynamically implement offloading configurations to dynamically offload the workload to the remote compute resource. The device may include an offloading module that collects and analyzes telemetry data and workload data to identify compatible offloading configurations stored in the memory. The offloading module may dynamically identify the compatible offloading configurations stored in the memory using a utility model, an artificial intelligence (AI) function, a machine learning (ML) algorithm, or some combination thereof. The offloading module may identify the compatible offloading configurations based on the power consumption setting, the computing power setting, the throughput setting, the memory setting, the IO bandwidth setting, or any other appropriate setting.

The device may include a processor that includes the offloading module. The offloading module may sample a portion of the workload. The workload may include a function that may be offloaded to a first remote compute resource or a second remote compute resource of the remote device. The offloading module may also sample a portion of a current workload of the first remote compute resource, the second remote compute resource, or some combination thereof. The offloading module may simulate offloading of the workload to the first remote compute resource and the second remote compute resource using the sampled portion of the workload, the sampled portion of the current workload, and telemetry data. The telemetry data may correspond to the first remote compute resource, the second remote compute resource, or some combination thereof. The first remote compute resource, the second remote compute resource, or some combination thereof may be configured to perform the workload according to the offloading configurations.

The offloading module may determine a rank score for each of the offloading configurations based on the simulation. For example, the offloading module may determine the rank scores using the utility model, the AI function, the ML algorithm, or some combination thereof. The offloading module, responsive to a rank score corresponding to an offloading configuration exceeding a threshold value, may offload the workload to the corresponding compute resource. For example, if the rank score corresponding to the first remote compute resource exceeds the threshold value, the offloading module may offload the workload to the first remote compute resource.

The offloading module may increase processing capacity of the device without increasing power consumption of the device. In addition, the offloading module may dynamically reuse the offloading configurations. The offloading module may perform various functions of the offloading process using an application programming interface (API), which may permit the offloading module to be implemented in various networks and devices.

These and other aspects of the present disclosure will be explained with reference to the accompanying figures. It is to be understood that the figures are diagrammatic and schematic representations of such example aspects, and are not limiting, nor are they necessarily drawn to scale. In the figures, features with like numbers indicate like structure and function unless described otherwise.

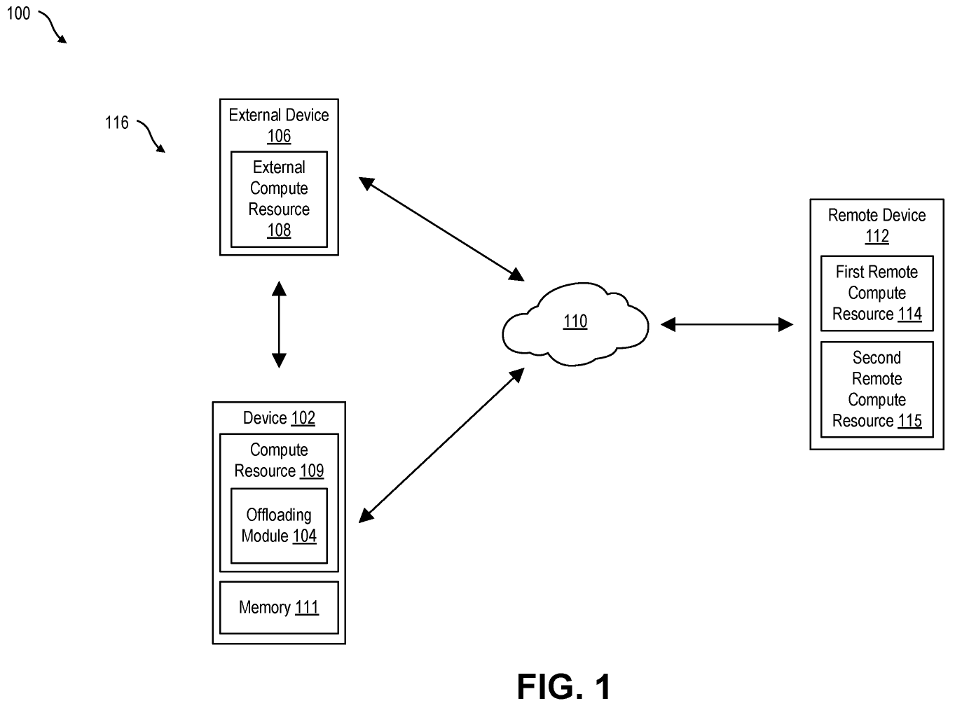

FIG. 1 illustrates a block diagram of an exemplary operational environment 100 to offload a workload to a compute resource, in accordance with at least one aspect described in the present disclosure.

The operational environment 100 may include a local area network (LAN) 116. The LAN 116 may include a device 102 and an external device 106. The device 102 and the external device 106 may be communicatively coupled to a remote device 112 via a network 110 (e.g., via the Internet). The network 110, the device 102, the external device 106, and the remote device 112 may form a wide area network (WAN). The device 102 and the external device 106 may be configured as edge devices that may offload the workload to the remote device 112. The remote device 112 may be configured as a network device.

The device 102 may include a compute resource 109 and a memory 111. The compute resource 109 may include an offloading module 104. The offloading module 104 may be communicatively coupled to an external compute resource 108 within the external device 106. The offloading module 104 may also be communicatively coupled to a first remote compute resource 114 and a second remote compute resource 115 within the remote device 112. The compute resource 109, the external compute resource 108, the first remote compute resource 114, and the second remote compute resource 115 may each include an xPU, an FPGA, an ASIC, a GPU, a CPU, an NIC, or some combination thereof.

The offloading module 104 may include code and routines configured to enable the compute resource 109 to perform one or more operations with respect to offloading the workload. Additionally or alternatively, the offloading module 104 may be implemented using hardware including a processor, a microprocessor (e.g., to perform or control performance of one or more operations), an FPGA, an ASIC, a NIC, a CPU, a GPU, a physical accelerator, or any other appropriate accelerator. The offloading module 104 may be implemented using a combination of hardware and software.

The memory 111 may store data being processed by the offloading module 104, the compute resource 109, or some combination thereof. In addition, the memory 111 may store telemetry data representative of a load and availability of the first remote compute resource 114 and the second remote compute resource 115, a disk space usage, a memory consumption, a performance setting, an API function, a telemetry probe for the first remote compute resource 114 and the second remote compute resource 115, or other data to permit the offloading module 104 or the compute resource 109 to perform the operations described in the present disclosure.

The offloading module 104 may identify each of the compute resources in the operational environment. For example, the offloading module 104 may identify the first remote compute resource 114, the second remote compute resource 115, the external compute resource108, and the compute resource 109 (collectively referred to in the present disclosure as “the compute resources”).

The offloading module 104 may determine the telemetry data of the compute resources. The offloading module 104 may generate an offload database. The memory 111 may store the offload database. The offload database may include the telemetry data and data corresponding to the compute resources. The offloading module 104 may identify offloading capabilities of the compute resources based on the offload database.

The offloading module 104 may determine whether a first workload is received. The first workload may be received from an application within the device 102, the external device 106, or another device (not illustrated in FIG. 1) within the LAN 116. The offloading module 104, responsive to receiving the first workload, may sample a portion of the first workload. In addition, the offloading module 104 may sample a portion of a current workload of the compute resources. If the compute resources do not include a current workload, the process described herein may be performed based on just the sampled workload.

The offloading module 104 may simulate offloading of the first workload to the compute resources. The offloading module 104 may simulate offloading of the first workload using the sampled portion of the first workload, the sampled portion of the current workload, the telemetry data, or some combination thereof. The compute resources may be configured to perform the first workload according to multiple offloading configurations. The offloading module 104 may simulate offloading of the first workload using the offloading configurations. The offloading module 104 may simulate offloading of the first workload using the AI function, the ML algorithm, or some combination thereof.

The offloading module 104 may determine a rank score for each of the offloading configurations based on the simulations. The offloading module 104, responsive to a rank score corresponding to an offloading configuration exceeding a threshold value, may offload the first workload to the corresponding compute resource. For example, if the rank score for the first remote compute resource 114 exceeds the threshold value, the offloading module 104 may offload the first workload to the first remote compute resource 114. If multiple rank scores exceed the threshold value, the offload module 104 may identify one of the compute resources that corresponds to a greatest rank score. The offloading module 104 may offload the first workload to the compute resource corresponding to the greatest rank score. For example, if the rank score for the first remote compute resource 114 and the second remote compute resource 115 both exceed the threshold value, the offloading module 104 may determine which of the first remote compute resource 114 and the second remote compute resource 115 correspond to the greatest rank score and may offload the first workload accordingly.

In addition, the offloading module 104 may determine whether the first workload has been processed by the corresponding compute resource. For example, if the first workload is offloaded to the first remote compute resource 114, the offloading module 104 may determine whether the first remote compute resource 114 has processed the first workload. The offloading module 104, responsive to the first offloaded workload being processed, may terminate an offloading mechanism with the corresponding compute resource. For example, the offloading module may terminate the offloading mechanism with the first remote compute resource.

The offloading module 104 may determine whether a second workload is received. The second workload may be received from an application within the device 102, the external device 106, or another device (not illustrated in FIG. 1) within the LAN 116. The offloading module 104, responsive to receiving the second workload, may sample a portion of the second workload. The offloading module 104 may sample the portion of the second workload in parallel to sampling the portion of the first workload, the portion of the current workload, or some combination thereof.

The offloading module 104 may simulate offloading of the second workload to the compute resources. The offloading module 104 may simulate offloading of the second workload using the sampled portion of the second workload, the sampled portion of the current workload, the sampled portion of the first workload, the telemetry data, or some combination thereof. The offloading module 104 may simulate offloading of the second workload in parallel with simulating offloading of the first workload. In addition, the offloading module 104 may simulate offloading of the first workload further using the sampled portion of the second workload.

The compute resources may be configured to perform the second workload according to the offloading configurations. The offloading module 104 may simulate offloading of the second workload using the offloading configurations. The offloading module 104 may simulate offloading of the second workload using the AI function, the ML algorithm, or some combination thereof.

The offloading module 104 may determine a rank score for each of the offloading configurations based on the parallel simulations of the first workload and the second workload. The offloading module 104, responsive to a rank score corresponding to an offloading configuration exceeding a threshold value, may offload the second workload to the corresponding compute resource. For example, if the rank score for the second remote compute resource 115 for the second workload exceeds the threshold value, the offloading module 104 may offload the second workload to the second remote compute resource 115.

The offloading module 104 may provide the telemetry data to the external compute resource 108, the first remote compute resource 114, the second remote compute resource 115, or some combination thereof.

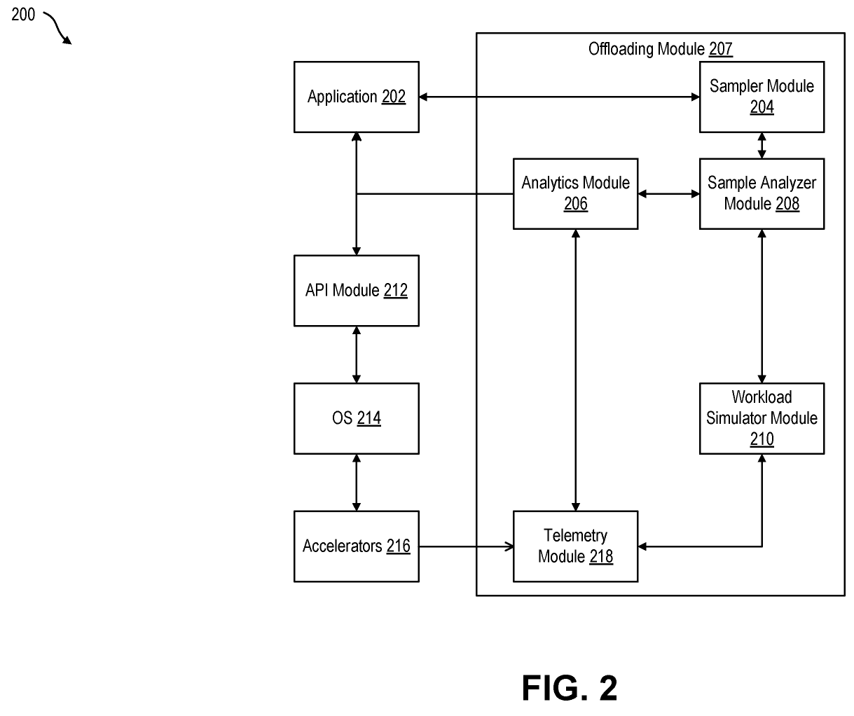

FIG. 2 illustrates a block diagram of an exemplary compute resource 200, in accordance with at least one aspect described in the present disclosure. The exemplary compute resource 200 may correspond to the compute resource 109 of FIG. 1. The exemplary compute resource 200 may include an application 200, an API module 212, an operating system (OS) 214, and an offloading module 207. The offloading module 207 may correspond to the offloading module 104 of FIG. 1. The OS 214 and the offloading module 207 may be communicatively coupled to accelerators 216. The accelerators 216 may correspond to the external compute resource 108, the first remote compute resource 114, the second remote compute resource 115, or some combination thereof of FIG. 1).

The offloading module 207 may include an analytics module 206, a sampler module 204, a sample analyzer module 208, a workload simulator module 210, and a telemetry module 216. The telemetry module 218 may be communicatively coupled to the accelerators 216. The analytics module 206 may be communicatively coupled to the application 202 and the API module 212. The analytics module 206 may be communicatively coupled to the application 202 and the API module 212 via an API.

The application 202 may provide the workload. The sampler module 204 may sample the portion of the workload. For example, the sampler module 204 may determine the workload has been received from the application 202 and identify a portion of the workload to sample. The sampled portion of the workload may be representative of the workload as a whole.

The telemetry module 218 may obtain the telemetry data corresponding to the accelerators 216. The telemetry data may indicate the current workload of the accelerators 216, processing capabilities of the accelerators 216, an API of the accelerators 216, or any other appropriate information.

The workload simulator module 210 may sample a portion of the current workload of the accelerators 216. The workload simulator module 210 may use the telemetry data to sample the portion of the current workload. The sampled portion of the current workload may be representative of the current workload as a whole.

The sample analyzer module 208 may analyze the sampled portion of the workload and the sampled portion of the current workload. The sample analyzer module 208 may determine whether the accelerators 216 are capable of processing the workload based on the analysis. The sample analyzer module 208 may determine whether a workload request to process the workload can be accepted by the accelerators. The sample analyzer module 208 may use the AI function, the ML algorithm, or some combination thereof to determine whether the workload request can be sent.

Responsive to the sample analyzer module 208 determining the workload request can be sent, the analytics module 206 may determine which offloading configuration to use to offload the workload. For example, the analytics module 206 may determine a rank score for each of the offloading configurations corresponding to the workload. The analytics module 206 may determine the rank scores using the utility model, the AI function, the ML algorithm, or some combination thereof. For example, for an initial operation (e.g., a first offloading iteration), the analytics module 206 may use the AI function, the ML algorithm, or some combination thereof. As another example, for subsequent operations (e.g., a second offloading iteration or more offloading iterations), the analytics module 206 may use the utility model, the AI function, the ML algorithm, or some combination thereof.

The rank scores may be determined based on a threshold of available resources within the accelerators 216 available to perform the first workload. The threshold may be pre-defined or configurable. The analytics module 206 may determine the rank scores based on the compute resource processing capacity, a memory resource capacity, a request resource capacity, a request memory resource capacity, a latency setting for a corresponding interface, an actual latency, a power utilization setting, or some combination thereof.

The analytics module 206 may determine the rank scores for each of the offloading configurations using the utility model according to Equation 1.

$$\left({e}_{c} - {r}_{c} + {e}_{n} - {r}_{n} + {l}_{n} - {l}_{n}\right) ∗ \frac{1}{V}$$

In Equation 1, e_{c} may represent available capacity of a corresponding compute resource, r_{c} may represent a requested compute resource capacity, eₙ may represent available memory resources of the corresponding compute resource, rₙ may represent a requested memory resource capacity, l_{c} may represent a latency setting of the workload, lₙ may represent an actual latency of the corresponding compute resource, and V may represent a pre-defined feature setting for workload offloading. The pre-defined feature setting for workload offloading may include a power setting, a network latency setting, a packet setting, a data throughput setting, or some combination thereof.

The analytics module 206 may determine whether any of the rank scores are equal to or greater than the threshold value. For example, the analytics module 206 may compare the rank scores determined according to Equation 1 to the threshold value. As another example, the analytics module 206 may compare the rank scores included in an output of the AI function or the ML algorithm to the threshold value.

Responsive to a rank score exceeding the threshold value, the analytics module may instruct the API module 212 to offload the workload to a corresponding accelerator of the accelerators 216. The API module 212 may use OS functions of the OS 214 to offload the workload. The corresponding accelerator of the accelerators 216 may perform the offloaded workload request.

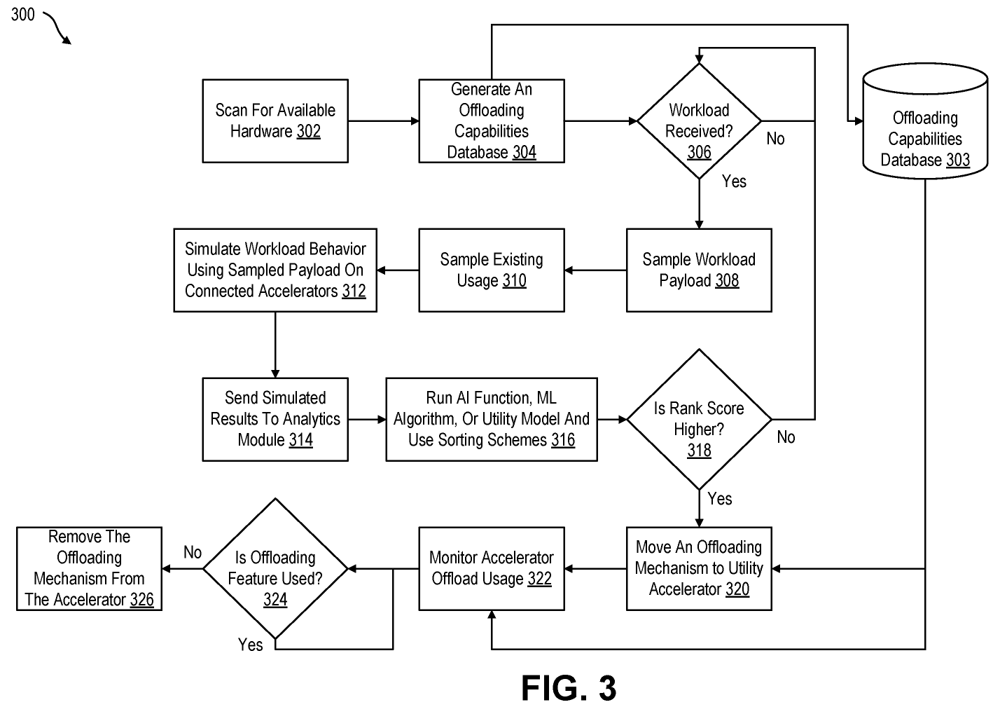

FIG. 3 illustrates a flowchart of an exemplary method 300 to offload the workload to a compute resource, in accordance with at least one aspect described in the present disclosure. The method 300 may be performed by any suitable system, apparatus, or device with respect to offloading the workload. For example, the device 102, the compute resource 109, the offloading module 104, the offloading module 207, or some combination thereof of FIGS. 1 and 2 may perform or direct performance of one or more of the operations associated with the method 300. The method 300 is described in relation to FIG. 3 as being performed by the offloading module 104 for example purposes. The method 300 may include one or more blocks 302, 304, 306, 308, 310, 312, 314, 316, 318, 320, 322, 324, and 326. Although illustrated with discrete blocks, the operations associated with one or more of the blocks of the method 300 may be divided into additional blocks, combined into fewer blocks, or eliminated, depending on the particular implementation.

At block 302, the offloading module 104 may scan for available hardware. The offloading module 104 may scan the device 102, the external device 106, the remote device 112, or some combination thereof for available compute resources (e.g., hardware accelerators). Block 302 may be followed by block 304.

At block 304, the offloading module 104 may generate an offloading capabilities database 303. The offloading capabilities database 303 may include or correspond to the telemetry data. The offloading capabilities database 303 may include data indicating associated capabilities, APIs, available telemetry probe information corresponding to the identified compute resources. Block 304 may be followed by block 306.

At block 306, the offloading module 104 may determine whether the workload is received. The offloading module 104 may determine whether the workload (e.g., a virtualized radio access network (vRAN) function, a user plane function (UPF), or any other appropriate function) has been received from an application or another device. If the workload is received, block 306 may be followed by block 308. If the workload is not received, block 306 may be repeated until the workload has been received.

At block 308, the offloading module 104 may sample workload payload. The offloading module 104 may sample a portion of the workload. The sampling may permit the offloading module 104 to determine which of the offloading configurations may be used for the workload. Block 308 may be followed by block 310.

At block 310, the offloading module 104 may sample existing usage. The offloading module 104 may sample the portion of the current workload of the compute resources. The sampled portion of the current workload may permit the offloading module 104 to determine whether the compute resources include open processing capacity. Block 310 may be followed by block 312.

At block 312, the offloading module 104 may simulate workload behavior using the sampled payload on connected accelerators. The offloading module 104 may simulate offloading the workload to the compute resources according to the offloading configurations. The offloading module 104 may also simulate offloading the workload to the compute resources using the sampled portion of the workload and the sampled portion of the current workload. The offloading module 104 may simulate offloading the workload using the AI function, the ML algorithm, or some combination thereof. Block 312 may be followed by block 314.

At block 314, the offloading module 104 may send results to the analytics module. The offloading module 104 may provide the simulation results to the analytics module 206. Block 314 may be followed by block 316.

At block 316, the offloading module 104 may run the AI function, the ML algorithm, or utility model and use sorting schemes. The offloading module 104 may determine the rank scores for each of the offloading configurations using the AI function, the ML algorithm, the utility model, or some combination thereof. The offloading module 104 may also use sorting schemes to arrange or filter the rank scores. The rank scores may be filtered based on algorithm ranks, a sub threshold value, or any other appropriate filtering scheme to remove low rank scores.

The offloading module 104 may determine the rank scores according to Equation 1. The offloading module 104 may determine the rank scores using an output of the AI function or the ML algorithm. Block 316 may be followed by block 318.

At block 318, the offloading module 104 may determine whether a rank score is higher than the threshold value. The offloading module 104 may determine whether any of the rank scores are equal to or greater than the threshold value. For example, the offloading module 104 may compare the rank scores determined according to Equation 1 to the threshold value. As another example, the offloading module 104 may compare the rank scores included in the output of the AI function or the ML algorithm to the threshold value. If multiple rank scores exceed the threshold value, the offload module 104 may identify one of the compute resources that corresponds to a greatest rank score.

If a rank score is equal to or greater than the threshold value, block 318 may be followed by block 320. If all of the rank scores are less than the threshold value, block 318 may be followed by block 306 and blocks 306, 308, 310, 312, 314, 316, and 318 may repeated until a at least one rank score associated with a subsequent workload exceeds the threshold value.

At block 320, the offloading module 104 may move an offloading mechanism to utility accelerator. The offloading module 104 may move the offloading mechanism to the compute resource corresponding to the rank score that exceeds the threshold value. The offloading mechanism may cause code to be to be executed on (e.g., the compute resource comprises a GPU) or to apply a gate structure to (e.g., the compute resource comprises an FPGA or an ASIC) the corresponding compute resource. The code to be executed or the applied gate structure may cause the compute resource to process the workload. The offloading module 104 may offload the workload to the compute resource corresponding to the rank score that exceeds the threshold value. In addition, The offloading module 104 may offload the workload to the compute resource corresponding to the greatest rank score. The offloading module 104 may move the offloading mechanism to the corresponding compute resource using the telemetry data stored in the offloading capabilities database 303. Block 320 may be followed by block 322.

At block 322, the offloading module 104 may monitor accelerator offload usage. The offloading module 104 may monitor usage of the compute resource that the workload was offloaded to by the workload. The offloading module 104 may monitor usage of the compute resources using the telemetry data stored in the offloading capabilities database 303. Block 322 may be followed by block 324.

At block 324, the offloading module 104 may determine whether the offloading feature is still being used. The offloading module 104 may determine whether the compute resource is still processing the workload. If the compute resource is not processing the workload, block 324 may be followed by block 326. If the compute resource is still processing the workload, block 324 may be repeated until the compute resource has completed processing the workload.

At block 326, the offloading module 104 may remove the offloading mechanism from the accelerator. The offloading module 104 may remove the offloading mechanism from the corresponding compute resource.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described aspects.

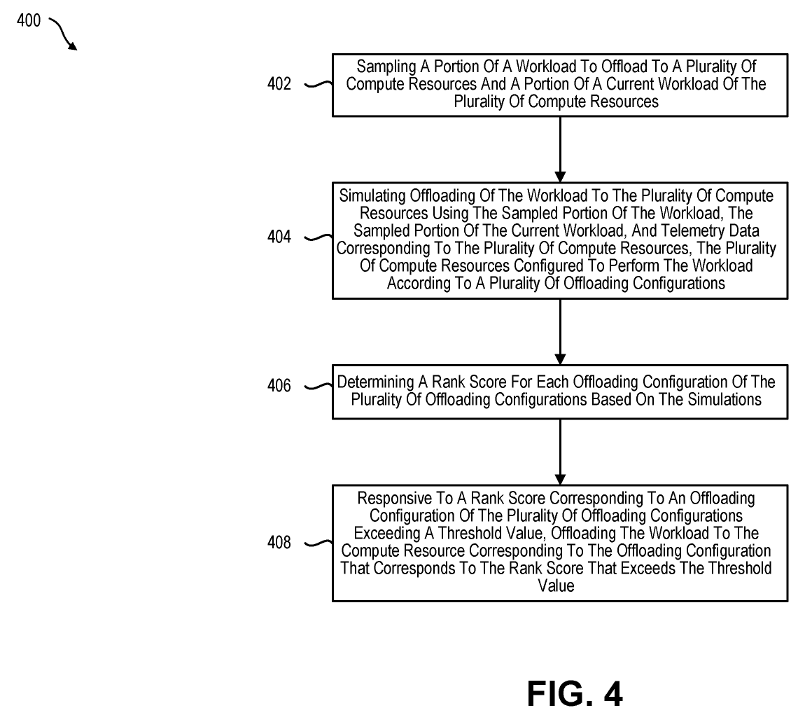

FIG. 4 illustrates a flowchart of an exemplary method 400 to offload a workload to a compute resource, in accordance with at least one aspect described in the present disclosure. The method 400 may be performed by any suitable system, apparatus, or device with respect to offloading the workload. For example, the device 102, the compute resource 109, the offloading module 104, the offloading module 207, or some combination thereof of FIGS. 1 and 2 may perform or direct performance of one or more of the operations associated with the method 400. The method 400 is described in relation to FIG. 4 as being performed by the offloading module 104 for example purposes. The method 400 may include one or more blocks 402, 404, 406, and 408. Although illustrated with discrete blocks, the operations associated with one or more of the blocks of the method 400 may be divided into additional blocks, combined into fewer blocks, or eliminated, depending on the particular implementation.

At block 402, the offloading module 104 may sample a portion of a workload to offload to a plurality of compute resources and a portion of a current workload of the plurality of compute resources. At block 404, the offloading module 104 may simulate offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations. At block 406, the offloading module 104 may determine a rank score for each offloading configuration of the plurality of offloading configurations based on the simulations. At block 408, responsive to a rank score corresponding to an offloading configuration of the plurality of offloading configurations exceeding a threshold value, the offloading module 104 may offload the workload to the compute resource corresponding to the offloading configuration that corresponds to the rank score that exceeds the threshold value.

Modifications, additions, or omissions may be made to the method 600 without departing from the scope of the present disclosure. For example, the operations of method 600 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described aspects.

One or more aspect described in the present disclosure may dynamically implement offloading configurations to dynamically offload the workload to the remote compute resources. The device may include an offloading module that collects and analyzes telemetry data and workload data to identify compatible offloading configurations stored in the memory.

The offloading module may include a Kubernetes orchestrator to schedule the applications within the device. The applications may use an amount of data and data content of a workload. The offloading module may offload the workload in accordance with settings of the device. The offloading module may offload the workload to the different compute resources through an API. The offloading module may sample the workload, a current workload of the accelerators, or some combination thereof to determine whether the workload can be offloaded to the compute resources.

The device may include a processor that includes the offloading module. The processor may include any appropriate accelerator. For example, the processor may include an xPU, an FPGA, an ASIC, a GPU, a CPU, an NIC, or some combination thereof. The device may also include a memory storing instructions in which, when executed by the processor, configure the processor.

The offloading module may identify compute resources that are available for workload offloading. The compute resources may include hardware accelerators, functional settings, or some combination thereof. The offloading module may also determine telemetry data of the compute resources. The telemetry data may include a load and availability, a disk space usage, a memory consumption, a performance setting, an API function, and a telemetry probe for each of the compute resources.

The offloading module may generate an offload database. The offload database may include the telemetry data and data corresponding to the identified compute resources. The offloading module may identify offloading capabilities of the compute resources based on the offload database.

The offloading module may also determine whether a first workload (e.g., a new workload) is received. Responsive to receiving the first workload, the offloading module may identify a data type and operation settings corresponding to the first workload. In addition, the offloading module may sample a portion of the first workload. The offloading module may also sample a portion of a current workload of the compute resources.

The offloading module may simulate offloading of the first workload to the compute resources using the sampled portion of the first workload, the sampled portion of the current workload, and the telemetry data. The compute resources may be configured to perform the first workload according to offloading configurations. The offloading module may simulate offloading of the first workload to the compute resources based on the offloading capabilities of the compute resources. The offloading module may simulate offloading of the first workload to the compute resources using a ML algorithm or an AI function.

The offloading module may determine a rank score for each of the offloading configurations based on the simulations. The offloading module may determine the rank scores based on compatibility of the operation settings, the identified data type, the functional settings, or some combination thereof. The offloading module may determine the rank score of each of the offloading configurations according to Equation 1.

Responsive to a rank score corresponding to an offloading configuration exceeding a threshold value, the offloading module may offload the first workload to the compute resource corresponding to the offloading configuration that corresponds to the rank score that exceeds the threshold value.

The offloading module may determine whether the first workload has been processed by the compute resource corresponding to the offloading configuration that corresponds to the rank score that exceeds the threshold value. Responsive to the first workload being processed, the offloading module may terminate an offloading mechanism with the corresponding compute resource.

The offloading module may determine whether a second workload (e.g., another new workload) is received. Responsive to receiving the second workload, the offloading module may identify a data type and operation settings corresponding to the second workload. In addition, the offloading module may sample a portion of the second workload. The offloading module may sample the portion of the second workload in parallel with sampling the portion of the first workload, the current workload, or some combination thereof.

The offloading module may simulate, in parallel with simulating offloading of the first workload, offloading of the second workload to the compute resources. The offloading module may simulate offloading of the second workload in parallel with simulating offloading of the first workload. The simulations may be performed using the sampled portion of the first workload, the sampled portion of the second workload, the sampled portion of the current workload, or some combination thereof.

The offloading module may determine the rank score for each of the offloading configurations based on the parallel simulations. Responsive to a rank score corresponding to an offloading configuration of the offloading configurations for the second workload exceeding a corresponding threshold value, the offloading module may offload the second workload to the compute resource corresponding to the offloading configuration that corresponds to the rank score that exceeds the threshold value in parallel to offloading the first workload.

Example 1 may include a device comprising a processor configured to: sample a portion of a workload to offload to a plurality of compute resources and a portion of a current workload of the plurality of compute resources; simulate offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations; determine a rank score for each offloading configuration of the plurality of offloading configurations based on the simulations; and responsive to a rank score corresponding to an offloading configuration of the plurality of offloading configurations exceeding a threshold value, offload the workload to the compute resource corresponding to the offloading configuration that corresponds to the rank score that exceeds the threshold value.

Example 2 may include the device of example 1, wherein the processor is further configured to: identify the plurality of compute resources that are available for workload offloading; determine the telemetry data of the plurality of compute resources; generate an offload database comprising the telemetry data and data corresponding to the identified compute resources; identify offloading capabilities of the plurality of compute resources based on the offload database, wherein the offloading of the workload to the plurality of compute resources is simulated based on the offloading capabilities of the plurality of compute resources; and determine whether the workload is received, wherein responsive to receiving the workload, the processor is configured to sample the portion of the workload and the portion of the current workload.

Example 3 may include the device of example 1, wherein the workload comprises a first workload, the processor is further configured to: sample a portion of a second workload in parallel with the portion of the first workload and the portion of the current workload of the plurality of compute resources; simulate, in parallel with simulating offloading of the first workload, offloading of the second workload to the plurality of compute resources, wherein the simulations are performed further using the sampled portion of the second workload; determine the rank score for each offloading configuration of the plurality of offloading configurations based on the parallel simulations; and responsive to a rank score corresponding to an offloading configuration of the plurality of offloading configurations for the portion of the second workload exceeding a corresponding threshold value, offload the second workload to the compute resource corresponding to the offloading configuration that corresponds to the rank score that exceeds the threshold value in parallel to offloading the first workload.

Example 4 may include the device of example 1, wherein the processor is configured to determine the rank score of each offloading configuration of the plurality of offloading configurations according to Equation 1.

Example 5 may include the device of example 1, wherein: the processor is further configured to identify a data type and a plurality of operation settings corresponding to the workload; the plurality of compute resources comprise a plurality of functional settings; and the processor is configured to determine the rank scores based on compatibility of the plurality of operation settings, the identified data type, and the plurality of functional settings.

Example 6 may include the device of example 1, wherein the telemetry data comprises a load and availability, a disk space usage, a memory consumption, a performance setting, an application programming interface function, and a telemetry probe for each compute resource of the plurality of compute resources.

Example 7 may include the device of example 1, wherein the processor is configured to simulate offloading of the workload to the plurality of compute resources using a machine learning algorithm or an artificial intelligence function.

Example 8 may include the device of example 1, wherein the plurality of compute resources comprises a plurality of hardware accelerators.

Example 9 may include the device of example 1, wherein the processor is further configured to: determine whether the offloaded workload has been processed by the compute resource corresponding to the offloading configuration that corresponds to the rank score that exceeds the threshold value; and responsive to the offloaded workload being processed, terminate an offloading mechanism with the corresponding compute resource.

Example 10 may include the device of example 1, further comprising: a memory storing instructions in which, when executed by the processor, configure the processor.

Example 11 may include a non-transitory computer-readable medium having a memory having computer-readable instructions stored thereon and a processor operatively coupled to the memory and configured to read and execute the computer-readable instructions to perform or control performance of operations comprising: sampling a portion of a workload to offload to a plurality of compute resources and a portion of a current workload of the plurality of compute resources; simulating offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations; determining a rank score for each offloading configuration of the plurality of offloading configurations based on the simulations; and responsive to a rank score corresponding to an offloading configuration of the plurality of offloading configurations exceeding a threshold value, offloading the workload to the compute resource corresponding to the offloading configuration that corresponds to the rank score that exceeds the threshold value.

Example 12 may include the non-transitory computer-readable medium of example 11, the operations further comprising: identifying the plurality of compute resources that are available for workload offloading; determining the telemetry data of the plurality of compute resources; generating an offload database comprising the telemetry data and data corresponding to the identified compute resources; identifying offloading capabilities of the plurality of compute resources based on the offload database, wherein the offloading of the workload to the plurality of compute resources is simulated based on the offloading capabilities of the plurality of compute resources; and determining whether the workload is received, wherein responsive to receiving the workload, the operations further comprising sampling the portion of the workload and the portion of the current workload.

Example 13 may include the non-transitory computer-readable medium of example 11, wherein the workload comprises a first workload, the operations further comprising: sampling a portion of a second workload in parallel with the portion of the first workload and the portion of the current workload of the plurality of compute resources; simulating, in parallel with simulating offloading of the first workload, offloading of the second workload to the plurality of compute resources, wherein the simulations are performed further using the sampled portion of the second workload; determining the rank score for each offloading configuration of the plurality of offloading configurations based on the parallel simulations; and responsive to a rank score corresponding to an offloading configuration of the plurality of offloading configurations for the portion of the second workload exceeding a corresponding threshold value, offloading the second workload to the compute resource corresponding to the offloading configuration that corresponds to the rank score that exceeds the threshold value in parallel to offloading the first workload.

Example 14 may include the non-transitory computer-readable medium of example 11, wherein the operation determining the rank score of each offloading configuration of the plurality of offloading configurations is performed according to Equation 1.

Example 15 may include the non-transitory computer-readable medium of example 11, the operations further comprising identifying a data type and a plurality of operation settings corresponding to the workload, wherein: the plurality of compute resources comprise a plurality of functional settings; and the operation determining the rank scores is performed based on compatibility of the plurality of operation settings, the identified data type, and the plurality of functional settings.

Example 16 may include the non-transitory computer-readable medium of example 11, wherein the telemetry data comprises a load and availability, a disk space usage, a memory consumption, a performance setting, an application programming interface function, and a telemetry probe for each compute resource of the plurality of compute resources.

Example 17 may include the non-transitory computer-readable medium of example 11, wherein the operation simulating offloading of the workload to the plurality of compute resources is performed using a machine learning algorithm or an artificial intelligence function.

Example 18 may include the non-transitory computer-readable medium of example 11, wherein the plurality of compute resources comprises a plurality of hardware accelerators.

Example 19 may include the non-transitory computer-readable medium of example 11, the operations further comprising: determining whether the offloaded workload has been processed by the compute resource corresponding to the offloading configuration that corresponds to the rank score that exceeds the threshold value; and responsive to the offloaded workload being processed, terminating an offloading mechanism with the corresponding compute resource.

Example 20 may include a system comprising: means to sample a portion of a workload to offload to a plurality of compute resources and a portion of a current workload of the plurality of compute resources; means to simulate offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations; means to determine a rank score for each offloading configuration of the plurality of offloading configurations based on the simulations; and responsive to a rank score corresponding to an offloading configuration of the plurality of offloading configurations exceeding a threshold value, means to offload the workload to the compute resource corresponding to the offloading configuration that corresponds to the rank score that exceeds the threshold value.

Example 21 may include the system of example 20 further comprising: means to identify the plurality of compute resources that are available for workload offloading; means to determine the telemetry data of the plurality of compute resources; means to generate an offload database comprising the telemetry data and data corresponding to the identified compute resources; means to identify offloading capabilities of the plurality of compute resources based on the offload database, wherein the offloading of the workload to the plurality of compute resources is simulated based on the offloading capabilities of the plurality of compute resources; and determine whether the workload is received, wherein responsive to receiving the workload, the system further comprises means to sample the portion of the workload and the portion of the current workload.

Example 22 may include the system of example 20, wherein the workload comprises a first workload, the system further comprising: means to sample a portion of a second workload in parallel with the portion of the first workload and the portion of the current workload of the plurality of compute resources; means to simulate, in parallel with simulating offloading of the first workload, offloading of the second workload to the plurality of compute resources, wherein the simulations are performed further using the sampled portion of the second workload; means to determine the rank score for each offloading configuration of the plurality of offloading configurations based on the parallel simulations; and responsive to a rank score corresponding to an offloading configuration of the plurality of offloading configurations for the portion of the second workload exceeding a corresponding threshold value, the system further comprises means to offload the second workload to the compute resource corresponding to the offloading configuration that corresponds to the rank score that exceeds the threshold value in parallel to offloading the first workload.

Example 23 may include the system of example 20, wherein the rank score of each offloading configuration of the plurality of offloading configurations is determined according to Equation 1.

Example 24 may include the system of example 20 further comprising means to identify a data type and a plurality of operation settings corresponding to the workload, wherein: the plurality of compute resources comprise a plurality of functional settings; and the system further comprises means to determine the rank scores based on compatibility of the plurality of operation settings, the identified data type, and the plurality of functional settings.

Example 25 may include the system of example 20, wherein the telemetry data comprises a load and availability, a disk space usage, a memory consumption, a performance setting, an application programming interface function, and a telemetry probe for each compute resource of the plurality of compute resources.

Example 26 may include the system of example 20, wherein the offloading of the workload to the plurality of compute resources is simulated using a machine learning algorithm or an artificial intelligence function.

Example 27 may include the system of example 20, wherein the plurality of compute resources comprises a plurality of hardware accelerators.

Example 28 may include the system of example 20 further comprising: means to determine whether the offloaded workload has been processed by the compute resource corresponding to the offloading configuration that corresponds to the rank score that exceeds the threshold value; and responsive to the offloaded workload being processed, the system further comprises means to terminate an offloading mechanism with the corresponding compute resource.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to aspects containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although aspects of the present disclosure have been described in detail, various changes, substitutions, and alterations could be made hereto without departing from the spirit and scope of the present disclosure.

What is claimed is:

1. A device comprising a processor configured to:
sample a portion of a workload to offload to a plurality of compute resources and a portion of a current workload of the plurality of compute resources;
simulate offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations;
determine a rank score for each offloading configuration of the plurality of offloading configurations based on the simulations; and
responsive to a rank score corresponding to an offloading configuration of the plurality of offloading configurations exceeding a threshold value, offload the workload to the compute resource corresponding to the offloading configuration that corresponds to the rank score that exceeds the threshold value.

2. The device of claim 1, wherein the processor is further configured to:
identify the plurality of compute resources that are available for workload offloading;
determine the telemetry data of the plurality of compute resources;
generate an offload database comprising the telemetry data and data corresponding to the identified compute resources;
identify offloading capabilities of the plurality of compute resources based on the offload database, wherein the offloading of the workload to the plurality of compute resources is simulated based on the offloading capabilities of the plurality of compute resources; and
determine whether the workload is received, wherein responsive to receiving the workload, the processor is configured to sample the portion of the workload and the portion of the current workload.

3. The device of claim 1, wherein the workload comprises a first workload, the processor is further configured to:
sample a portion of a second workload in parallel with the portion of the first workload and the portion of the current workload of the plurality of compute resources;
simulate, in parallel with simulating offloading of the first workload, offloading of the second workload to the plurality of compute resources, wherein the simulations are performed further using the sampled portion of the second workload;
determine the rank score for each offloading configuration of the plurality of offloading configurations based on the parallel simulations; and
responsive to a rank score corresponding to an offloading configuration of the plurality of offloading configurations for the portion of the second workload exceeding a corresponding threshold value, offload the second workload to the compute resource corresponding to the offloading configuration that corresponds to the rank score that exceeds the threshold value in parallel to offloading the first workload.

4. The device of claim 1, wherein the processor is configured to determine the rank score of each offloading configuration of the plurality of offloading configurations according to:
$$\left({e}_{c} - {r}_{c} + {e}_{n} - {r}_{n} + {l}_{c} - {l}_{n}\right) ∗ \frac{1}{V}$$
in which, e_{c} represents available capacity of a corresponding compute resource, r_{c} represents a requested compute resource capacity, eₙ represents available memory resources of the corresponding compute resource, rₙ represents a requested memory resource capacity, I_{c} represents a latency setting of the workload, Iₙ represents an actual latency of the corresponding compute resource, and V represents a pre-defined feature setting for workload offloading.

5. The device of claim 1, wherein:
the processor is further configured to identify a data type and a plurality of operation settings corresponding to the workload;
the plurality of compute resources comprise a plurality of functional settings; and
the processor is configured to determine the rank scores based on compatibility of the plurality of operation settings, the identified data type, and the plurality of functional settings.

6. The device of claim 1, wherein the telemetry data comprises a load and availability, a disk space usage, a memory consumption, a performance setting, an application programming interface function, and a telemetry probe for each compute resource of the plurality of compute resources.

7. The device of claim 1, wherein the processor is configured to simulate offloading of the workload to the plurality of compute resources using a machine learning algorithm or an artificial intelligence function.

8. A non-transitory computer-readable medium having a memory having computer-readable instructions stored thereon and a processor operatively coupled to the memory and configured to read and execute the computer-readable instructions to perform or control performance of operations comprising:
sampling a portion of a workload to offload to a plurality of compute resources and a portion of a current workload of the plurality of compute resources;
simulating offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations;
determining a rank score for each offloading configuration of the plurality of offloading configurations based on the simulations; and
responsive to a rank score corresponding to an offloading configuration of the plurality of offloading configurations exceeding a threshold value, offloading the workload to the compute resource corresponding to the offloading configuration that corresponds to the rank score that exceeds the threshold value.

9. The non-transitory computer-readable medium of claim 8, the operations further comprising:
identifying the plurality of compute resources that are available for workload offloading;
determining the telemetry data of the plurality of compute resources;
generating an offload database comprising the telemetry data and data corresponding to the identified compute resources;
identifying offloading capabilities of the plurality of compute resources based on the offload database, wherein the offloading of the workload to the plurality of compute resources is simulated based on the offloading capabilities of the plurality of compute resources; and
determining whether the workload is received, wherein responsive to receiving the workload, the operations further comprising sampling the portion of the workload and the portion of the current workload.

10. The non-transitory computer-readable medium of claim 8, wherein the workload comprises a first workload, the operations further comprising:
sampling a portion of a second workload in parallel with the portion of the first workload and the portion of the current workload of the plurality of compute resources;
simulating, in parallel with simulating offloading of the first workload, offloading of the second workload to the plurality of compute resources, wherein the simulations are performed further using the sampled portion of the second workload;
determining the rank score for each offloading configuration of the plurality of offloading configurations based on the parallel simulations; and
responsive to a rank score corresponding to an offloading configuration of the plurality of offloading configurations for the portion of the second workload exceeding a corresponding threshold value, offloading the second workload to the compute resource corresponding to the offloading configuration that corresponds to the rank score that exceeds the threshold value in parallel to offloading the first workload.

11. The non-transitory computer-readable medium of claim 8, the operations further comprising identifying a data type and a plurality of operation settings corresponding to the workload, wherein:
the plurality of compute resources comprise a plurality of functional settings; and
the operation determining the rank scores is performed based on compatibility of the plurality of operation settings, the identified data type, and the plurality of functional settings.

12. The non-transitory computer-readable medium of claim 8, wherein the telemetry data comprises a load and availability, a disk space usage, a memory consumption, a performance setting, an application programming interface function, and a telemetry probe for each compute resource of the plurality of compute resources.

13. The non-transitory computer-readable medium of claim 8, wherein the operation simulating offloading of the workload to the plurality of compute resources is performed using a machine learning algorithm or an artificial intelligence function.

14. The non-transitory computer-readable medium of claim 8, the operations further comprising:
determining whether the offloaded workload has been processed by the compute resource corresponding to the offloading configuration that corresponds to the rank score that exceeds the threshold value; and
responsive to the offloaded workload being processed, terminating an offloading mechanism with the corresponding compute resource.

15. A system comprising:
means to sample a portion of a workload to offload to a plurality of compute resources and a portion of a current workload of the plurality of compute resources;
means to simulate offloading of the workload to the plurality of compute resources using the sampled portion of the workload, the sampled portion of the current workload, and telemetry data corresponding to the plurality of compute resources, the plurality of compute resources configured to perform the workload according to a plurality of offloading configurations;
means to determine a rank score for each offloading configuration of the plurality of offloading configurations based on the simulations; and
responsive to a rank score corresponding to an offloading configuration of the plurality of offloading configurations exceeding a threshold value, means to offload the workload to the compute resource corresponding to the offloading configuration that corresponds to the rank score that exceeds the threshold value.

16. The system of claim 15 further comprising:
means to identify the plurality of compute resources that are available for workload offloading;
means to determine the telemetry data of the plurality of compute resources;
means to generate an offload database comprising the telemetry data and data corresponding to the identified compute resources;
means to identify offloading capabilities of the plurality of compute resources based on the offload database, wherein the offloading of the workload to the plurality of compute resources is simulated based on the offloading capabilities of the plurality of compute resources; and
determine whether the workload is received, wherein responsive to receiving the workload, the system further comprises means to sample the portion of the workload and the portion of the current workload.

17. The system of claim 15, wherein the workload comprises a first workload, the system further comprising:
means to sample a portion of a second workload in parallel with the portion of the first workload and the portion of the current workload of the plurality of compute resources;
means to simulate, in parallel with simulating offloading of the first workload, offloading of the second workload to the plurality of compute resources, wherein the simulations are performed further using the sampled portion of the second workload;
means to determine the rank score for each offloading configuration of the plurality of offloading configurations based on the parallel simulations; and
responsive to a rank score corresponding to an offloading configuration of the plurality of offloading configurations for the portion of the second workload exceeding a corresponding threshold value, the system further comprises means to offload the second workload to the compute resource corresponding to the offloading configuration that corresponds to the rank score that exceeds the threshold value in parallel to offloading the first workload.

18. The system of claim 15, wherein the rank score of each offloading configuration of the plurality of offloading configurations is determined according to:
$$\left({e}_{c} - {r}_{c} + {e}_{n} - {r}_{n} + {l}_{c} - {l}_{n}\right) ∗ \frac{1}{V}$$
in which, e_{c} represents available capacity of a corresponding compute resource, r_{c} represents a requested compute resource capacity, eₙ represents available memory resources of the corresponding compute resource, rₙ represents a requested memory resource capacity, l_{c} represents a latency setting of the workload, lₙ represents an actual latency of the corresponding compute resource, and V represents a pre-defined feature setting for workload offloading.

19. The system of claim 15, wherein the telemetry data comprises a load and availability, a disk space usage, a memory consumption, a performance setting, an application programming interface function, and a telemetry probe for each compute resource of the plurality of compute resources.

20. The system of claim 15 further comprising:
means to determine whether the offloaded workload has been processed by the compute resource corresponding to the offloading configuration that corresponds to the rank score that exceeds the threshold value; and
responsive to the offloaded workload being processed, the system further comprises means to terminate an offloading mechanism with the corresponding compute resource.
